(19) United States
(12) Patent Application Publication
(10) Pub. No.: US 2026/0026496 A1
(43) Pub. Date: Jan. 29, 2026

(54) EX VIVO WHOLE EYEBALL PRESERVATION SYSTEM

(71) Applicant: BioMedInnovations, Inc., Winston-Salem, NC (US)

(72) Inventors: Varun Lingaiah Kopparthy, Raleigh, NC (US); Vijay Saradhi Gorantla, Winston Salem, NC (US); Carrie Bordeaux DiMarzio, Davidson, NC (US)

(21) Appl. No.: 19/279,575

(22) Filed: Jul. 24, 2025

Related U.S. Application Data
(60) Provisional application No. 63/675,312, filed on Jul. 25, 2024.

(51) Int. Cl. A01N 1/143

(52) U.S. Cl. CPC A01N 1/143

(57) ABSTRACT

An apparatus for perfusing an eye or portions thereof, includes: an enclosure configured to provide physical protection to an eye or portions thereof; and a fluid flow loop extending from an outlet connection of the enclosure to an inlet connection of the enclosure, the fluid flow loop including a pump, an oxygenator, and a waveform generator; and at least one sensor operable to sense a parameter of a perfusate flowing within the fluid flow loop and generate a signal representative thereof; and a control and monitoring unit configured to receive.

### BACKGROUND OF THE INVENTION

This invention relates generally to organ support processes, and more particularly to methods and apparatus for carrying out the preservation of the whole eyeball or globe with adnexal tissues.

It is known that some devices are available which circulate an aqueous organ preservation fluid, such as “Belzer's solution” or “University of Wisconsin” [UW] solution or “Histidine-Tryptophan-Ketoglutarate” (HTK) [Custodiol™] solution, whole blood, or customized acellular perfusate to mimic the blood, through organs which have been procured for transplantation. This action sustains the viability of the organ while it is outside the body by attempting to preserve cell and tissue survival and metabolism, and increases the limited “shelf life” of transplant organs compared to conventional chilled storage.

However, there remains a need specifically for the preservation of eyes, which have unique characteristics compared to other internal organs.

### BRIEF SUMMARY OF THE INVENTION

This need is addressed by an apparatus which is operable to perfusing oxygenated fluid through an eye.

According to one aspect of the technology described herein, an apparatus for perfusing an eye or portions thereof includes: an enclosure configured to provide physical protection to an eye or portions thereof; a fluid flow loop extending from an outlet connection of the enclosure to an inlet connection of the enclosure, the fluid flow loop including a pump, an oxygenator, and a waveform generator; and at least one sensor operable to sense a parameter of a perfusate flowing within the fluid flow loop and generate a signal representative thereof; and a control and monitoring unit configured to receive the signal from the at least one sensor and adjust the parameter in response thereto.

According to another aspect of the technology described herein, a method of perfusing an eye or portions thereof includes: placing the eye or portions thereof in an enclosure configured to provide physical protection to an organ; coupling the eye or portions thereof to a fluid flow loop including a pump, an oxygenator, and a waveform generator; using the pump to circulate perfusion fluid through the fluid flow loop; using the oxygenator to introduce oxygen into the perfusion fluid; and using the waveform generator to impress a preselected waveform profile upon the fluid flow in the fluid loop.

### BRIEF DESCRIPTION OF THE DRAWINGS

The invention may be best understood by reference to the following description taken in conjunction with the accompanying drawing figures in which:

FIG. 1 is a schematic view of an organ support apparatus constructed according to an aspect of the present invention;

FIG. 2 is a schematic view of a pressure waveform generator or pulse generator of the organ support apparatus of FIG. 1;

FIG. 3 is a schematic graph of a flow characteristic of the apparatus in operation;

FIG. 4 is a diagram of a portion of the vascular anatomy of the eye; and

FIG. 5 is a schematic graph of another example flow characteristic of the apparatus in operation.

### DETAILED DESCRIPTION OF THE INVENTION

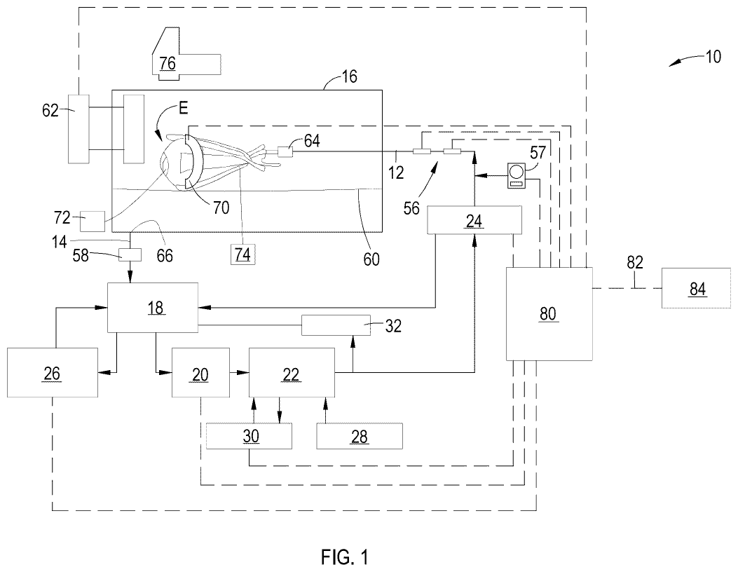

Referring to the drawings wherein identical reference numerals denote the same elements throughout the various views, FIG. 1 depicts an exemplary eye preservation apparatus 10, suitable for protecting an eye and perfusing a fluid through it. The apparatus 10 comprises a fluid circuit defined by a suitable conduit such as plastic tubing. The apparatus 10 is connected to an eye to be supported, depicted generally at “E”, by an inlet line 12 and an outlet line 14. The eye E is contained in an enclosure 16.

The basic elements of the apparatus 10 include a fluid flow loop having, in sequential fluid flow order, a fluid reservoir 18, a circulation pump 20, an oxygenator 22, a fluid waveform generator 24 (alternatively referred to as a pulse generator), and the enclosure 16.

The apparatus 10 may include a dialysis unit 26 for filtering endogenous or exogenous material from the process fluid. In this example, the unit 26 is coupled to the reservoir 18 in a separate loop.

The circulation pump 20 may be any type of pump which can provide the required flow rates and pressures and is hygienic. The process fluid may be blood containing cells, plasma, and expanders, or other therapeutic fluids containing complex molecules. Examples of process fluids that may be used in different processes include aqueous organ preservatives such as “AMES' solution” and “Modified AMES' solution”, “University of Wisconsin solution”, “Belzer's solution”, “h\Histidine, tryptophan, and ketoglutarate (HTK)”, whole blood, plasma, serum, crystalloid and non-crystalloid expanders, and oxygen-carrying molecules. In addition, for active oxygenation, polymerized hemoglobin products such as HBOC-201, and nanoparticle-based emulsions can be added to the preservative solutions. Preferably the circulation pump 20 is a type which does not tend to damage these fluid components. Examples of suitable pumps include peristaltic and centrifugal types. The fluid may also contain drugs/medications to minimize/prevent ischemia-reperfusion injury. In addition, the fluid may also contain small molecule therapeutics for immunomodulation, immunosuppression, neuroprotection, and other indications including but not limited to maintaining tissue viability, ocular pressures, or retinal survival.

The oxygenator 22 is of a known type which is configured to introduce oxygen into the fluid stream from an external source. The oxygenator 22 is coupled to a source of oxygen, such as the illustrated tank 28, which may contain, for example, gaseous oxygen or a gas mixture like carbogen.

A heat exchanger 30 is operable to heat or cool the process fluid to a desired temperature. In the illustrated example, it is connected in a separate loop with the oxygenator 22. Alternatively, it could be positioned inline in the fluid flow loop.

Warming of the organ can also be achieved by a precise method of warming in a controlled manner with materials or techniques to achieve heat transfer that support the organ in the cassette. Similarly, cooling may be achieved with Peltier colling achieved by the material properties of the organ support.

A sampling port 32 is provided downstream of the oxygenator 22, and drains back to the reservoir 18. The sampling port 32 allows for convenient access to perfusate samples and facilitates the administration of necessary interventions or medications.

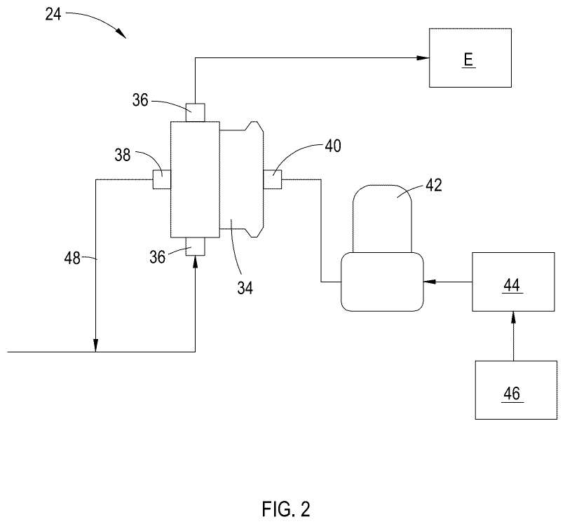

The waveform generator 24 is effective to receive process fluid from the fluid circuit and reduce the pressure to a suitable value for the eye E, for example about 40 to about 180 mm Hg and to apply a pressure profile thereto, so that the eye E receives a pulsating flow which mimics the flow characteristics of a patient's heart. In the illustrated example, shown in FIG. 2, the waveform generator 24 comprises a diaphragm-type pressure regulator 34 having a pair of process ports 36 connected to the fluid circuit, a bypass port 38 connected to a point upstream of the waveform generator 24, and a reference port 40 which is connected to an electropneumatic (E/P) transducer 42 of a known type. Suitable waveform generators of this type are commercially available. The E/P transducer 42 is in turn connected to a programmable electronic controller 44 or computer through an input/output (I/O) card 46.

Referring again to FIG. 1, the waveform generator 24 receives blood flow from the pump 14 and applies a cyclic pressure pulse thereto, as commanded by the controller 44, so that the eye E receives a pulsating flow which mimics the flow characteristics of the patient's heart. An exhaust line 48 routes exhaust fluid from the waveform generator 24 back to an upstream portion of the apparatus, for the example the inlet of the circulation pump 20.

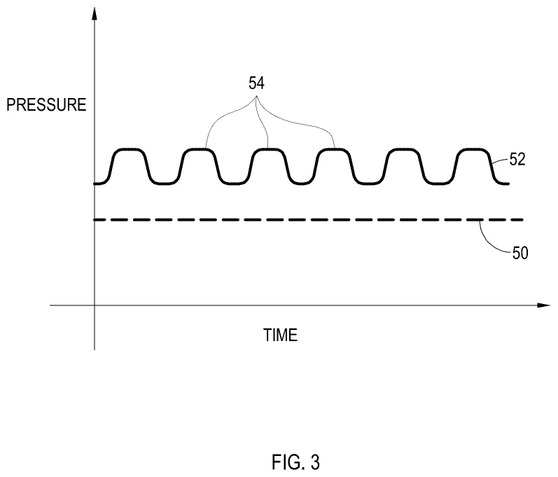

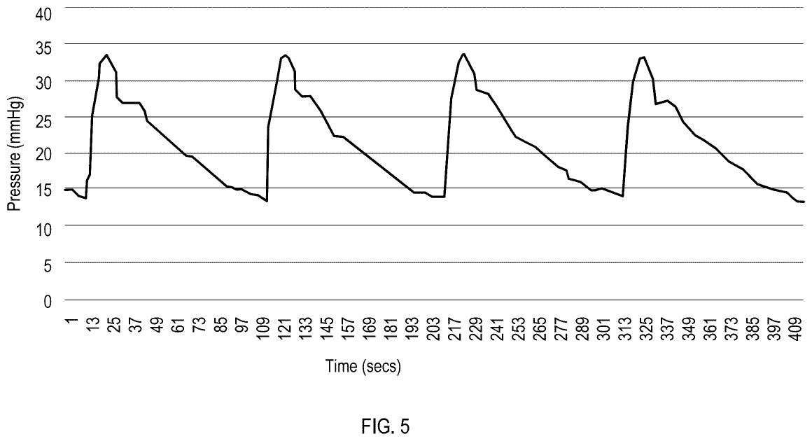

FIG. 3 illustrates an example of the flow characteristics that can be obtained. The dashed line 50 represents the essentially constant pressure output of the circulation pump 20, while the solid line 52 represents the total pressure after the fluid passes through the waveform generator 24. Appropriate feedback signals are provided to the controller 44 representative of the output of the apparatus 10. In the illustrated example, the flow has a pulsating pressure with peaks 54 occurring at regular intervals. A quasi-square-wave flow characteristic is shown; however, by careful control programming, almost any wave shape desired can be obtained. This allows the apparatus 10 to closely emulate the flow characteristics of the patient's heart or to generate specific preferred waveforms as determined by the physician or technician involved in a particular procedure. It is thought that this will maximize the “shelf life” of the eye E. FIG. 5 illustrates another example of a waveform that can be achieved.

The apparatus 10 may include monitoring and feedback systems. These may be used to continuously assess parameters such as temperature, pH, oxygen levels, and intraocular pressure (IOP). These systems provide real-time data to ensure optimal preservation conditions and allow for timely intervention if parameters deviate from the desired range. In the illustrated example, this function may be implemented using one or more sensor arrays.

An upstream sensor array 56 may be disposed between the waveform generator 24 and the enclosure 16. It may include one or more sensors for evaluating the condition of the process fluid in the fluid circuit, such as flow rate, pressure, temperature, viscosity, osmolality, bubble detection, oxygenation levels, gas and/or chemical composition, pH, and/or CO₂ levels. Known types of transducers and sensors are utilized to generate signals representative of each measured parameter.

Some or all of these sensors may be incorporated into feedback control loops to provide control of various parameters. Some examples follow.

The apparatus 10 may be configured to maintain the perfusate within a physiological pH range of approximately 7.40-7.52. For example, the control and monitoring unit (described below) may accept input from the sensor array 56 and introduce additives to the perfusate using an infusion pump 57 or other suitable device as required to maintain the desired pH.

The apparatus 10 may be configured to maintain the perfusate at an osmolality of approximately 304 mOsm. For example, the control and monitoring unit (described below) may accept input from the sensor array 56 and introduce additives to the perfusate using an infusion pump 57 or other suitable device as required to maintain the desired osmolality.

The apparatus 10 may be configured to actively adjust the perfusate's viscosity to mimic the natural vitreous's viscoelastic properties, ranging from approximately 300-2000 cP. For example, the control and monitoring unit (described below) may accept input from the sensor array 56 and introduce additives to the perfusate using an infusion pump 57 or other suitable device as required to maintain the desired viscosity.

The consumption of oxygen is a critical viability measure for the eye. The sensors positioned in-line in the arterial and venous flow will continuously measure the real-time oxygen data. The control unit will compute the oxygen consumption.

The control and monitoring unit (described below) can monitor the real-time levels of the perfusate chemistry and infuse deficient chemicals and nutrients to maintain homeostasis. The control system includes an artificial intelligence and machine learning algorithm for predictive analysis of the parameters and assess the viability of the organ.

The artificial intelligence and machine learning algorithm may further be configured for predictive analysis of the optimal preservation duration and the earliest detection of cellular or tissue degradation trends, based on monitored parameters and metabolic markers.

A downstream sensor array 58 may be disposed between the enclosure 16 and the reservoir 18. It may include one or more sensors for evaluating the condition of the process fluid in the fluid circuit, such as flow rate, pressure, temperature, bubble detection, oxygenation levels, gas and/or chemical composition, pH, and/or CO₂ levels. Known types of transducers and sensors are utilized to generate signals representative of each measured parameter.

In an additional embodiment, the perfusion loop includes at least one spectroscopic flow cell (such as a flow-through cell or flow-through cuvette) designed for recording spectra through various spectroscopic methods, including UV-VIS spectroscopy, fluorescence spectroscopy, Raman spectroscopy, circular dichroism spectroscopy, and/or (near) infrared spectroscopy. This flow cell allows for the detection and analysis of at least one compound or molecule present in the perfusate. Integrated within the perfusion loop (which may comprise a tube set or disposable set), the perfusate flows through the spectroscopic flow cell. In a preferred embodiment, fluoroscopic measurements enable the identification of the presence or absence of the target molecule within the perfusate. The spectroscopic flow cell can be positioned at any suitable location within the loop assembly. The spectroscopic flow cell can measure molecules such as flavin mononucleotide (FMN), NADH, ADH, and succinate.

Comparing information from the upstream and downstream sensor arrays 56, 58 facilitates precise monitoring of tissue viability. For example, the differential oxygenation level information from the two arrays may permit measuring the oxygen consumption of the tissue within the preserved eye E.

The enclosure 16 (see FIG. 1) provides physical protection to the eye E. The organ enclosure may be sized and configured to house two or more eyes. It may be constructed from sterilizable transparent medical-grade polymer, and is provided with connections between the eye E and the inlet and outlet lines 12 and 14 respectively. It may include an air filtration system (not shown) to prevent contamination.

In the illustrated example, the enclosure 16 includes a flexible hammock 60 that supports the eye E while evenly distributing the pressure. The hammock 60 or the enclosure itself may include an integrated weight monitoring system to assess the weight of the eye during preservation, providing valuable data for preservation quality assessment. For example, the hammock 60 may include a weight scale or a strain gauge to sense the weight of the eye E.

The eye can also be placed submerged or floating in the perfusate-filled cavity/chamber inside the enclosure. The perfusate is actively oxygenated and circulated.

Optionally, a hydrogel-forming solution may be introduced into the enclosure 16, and polymerized in situ around or within the preserved eye or specific ocular tissues to form a hydrophilic vitreous substitute. Nonlimiting examples of Polymerization catalysts for hydrogels include cellulose, chitosan, or hyaluronic acid.

Optionally, The vitreous body of the eye E may be perforated with one or more cannulas and perfused with a hydrogel-forming solution to replace and/or regenerate the vitreous body.

The enclosure 16 incorporates a temperature control mechanism to regulate the temperature within. Maintaining the appropriate temperature is essential for preserving tissue viability and preventing cellular degradation. In the illustrated example, a small-scale HVAC unit 62 such as a conventional heat pump is shown for this function.

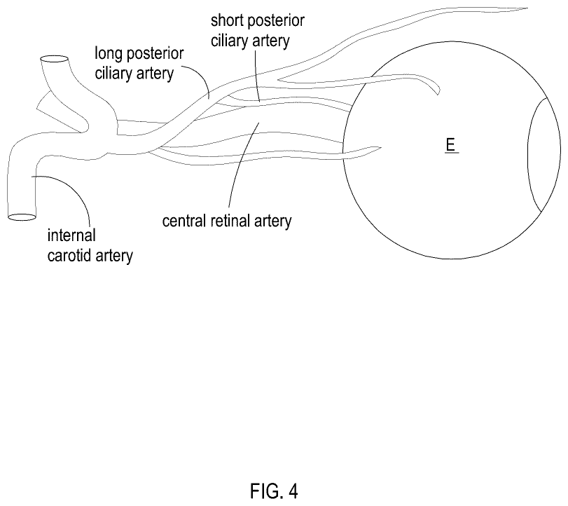

The enclosure 16 includes means for coupling one or both of the inlet line 12 and the outlet line 14 in fluid flow communication with the eye E. The enclosure is designed to provide non-traumatic support to the eye. The enclosure is ergonomically designed and encapsulates the organ and fluid for transport applications. In the illustrated example, the inlet line 12 is coupled to the eye E using a cannula 64. FIG. 4 illustrates the vascular anatomy of the E. It can be seen that there are several arteries which are candidates for cannulation, such as the internal carotid artery. Optionally, the inlet line 12 may have two or more branches within the enclosure 16, each provided with a cannula. This allows for the simultaneous preservation of two or more eyes. The outlet line 18 is coupled to a drain port 66 in the enclosure 16 and collects fluid which has been perfused through the eye E. Cannulation of various arterial structures will be achieved using specifically designed cannulas with varying sizes that enable rapid connectivity.

Ocular tissues such as but are not limited to the vitreous body, the canal of Schlemm, the corneal limbus, the whole retinal/optic cup, the lacrimal gland, and the eye globe.

Vitreous perfusion can also be achieved by inserting a specialized (vitreoretinal) cannula into the vitreous body. Two cannulas will be used for inlet and outlet of the perfusate to preserve the vitreous body.

Corneal limbus preservation could allow for the preservation of stem cells that are limbal epithelial stem cells (LESCs) and corneal stromal stem cells (CSSCs).

The enclosure 16 may include a lighting system, shown schematically at 68. The lighting system 68 may be configured to provide gentle illumination within the enclosure. This lighting may be dim and may be limited to specific wavelengths, such as dim red light, to minimize potential damage to the preserved tissues while allowing for observation or imaging purposes. As an example, multi-color LEDs with appropriate drivers may be provided for this purpose.

Intraocular pressure sensors 70 may be placed in contact with or implanted into the eye E, enabling continuous monitoring of intraocular pressure levels to ensure optimal preservation conditions.

The apparatus 10 may be configured to maintain intraocular pressure (IOP) of the preserved eye below a selected limit such as 20 mmHg. For example, the control and monitoring unit (described below) may accept input from the intraocular pressure sensors 70 and modulate the operation of the pump 20 and/or waveform generator 24 as required to maintain the desired intraocular pressure.

The apparatus may include an Electroretinography (ERG) apparatus 72. this permits integration of ERG functionality for continuously assessing retinal function during the preservation process, enabling real-time evaluation of ocular cell survival.

The apparatus may incorporate dark and light controls for evaluating retinal ganglion cell activity and a monitoring system 74 to evaluate the responsiveness of ocular tissues to light stimuli, providing insights into tissue functionality and health status.

The apparatus may include an interferometer 76 with a field of view of the eye E. this permits implementation of Optical Coherence Tomography (OCT) for non-invasive imaging and assessment of ocular structures during preservation, allowing for detailed analysis of tissue integrity.

A control and monitoring unit 80 is provided for the apparatus 10. The control and monitoring unit 80 includes or more processors and may be a general-purpose microcomputer of a known type, such as a PC-based computer, or may be a custom processor, or may incorporate one or more programmable logic controllers (PLC). The control and monitoring unit 80 is operably connected to the individual functional components of the apparatus 10 in order to receive data and/or transmit commands to each component. For example, the control and monitoring unit 80 receives data about the process fluid condition from the sensor arrays 56, 58. It transmits pressure waveform commands to the waveform generator 24 to maintain a desired pressure waveform entering the eye E. The control and monitoring unit 80 may communicate directly with the functional components of the apparatus 10, or through intermediate devices such as the controller 44 described above. The data connections between the control and monitoring unit 80 and the individual components may be through wired or wireless channels. The control and monitoring unit 80 may be used for feedback control of the components in the apparatus 10 based on one or more inputs. Furthermore, pressure, flow, and/or temperature data from the various sensors may be used to adjust or “tune” the operating parameters of the apparatus 10. Stated another way, the control and monitoring unit 80 is configured to receive signals from at least one sensor and adjust a parameter of the apparatus 10 in response thereto.

The control and monitoring unit 80 contains a secure wireless data transmission for real-time sharing of location and organ viability information.

The apparatus 10 may be provided with a data network connection 82 coupled to the control and monitoring unit 80. The purpose of the data network connection 82 is to bidirectionally exchange telemetry data with a remote computer 84. This may be used to monitor the performance of the apparatus 10 and/or to transmit commands to the apparatus 10 remotely. The data connection between the control and monitoring unit 80 and the remote computer 84 may be wired or wireless.

With appropriate programming, the control and monitoring unit 80 may be automatically flow regulating for different eye tissue masses, thermal conditions that influence vascular elasticity, variable perfusate flow restrictions at the organ level, and variable fluid characteristics (e.g. viscosity, entrained shear sensitive solids, etc.), while precisely maintaining the process fluid flow between narrowly defined systolic and diastolic pressure set points. This will virtually eliminate the potential for permanent capillary damage due to over pressurization of organ vasculature.

The control and monitoring unit may be further configured to dynamically adjust perfusate flow characteristics, including systolic and diastolic pressure set points, to compensate for variable thermal conditions influencing vascular elasticity and variable perfusate flow restrictions at the organ level.

The apparatus 10 may be configured to maintain the viability and functional integrity of hyalocytes within the vitreous cortex of the preserved eye. Sensors for this function can be of indirect measurement of viablity of cells using biochemical signaling molecules. The sensors could be electrochemical and optical.

The apparatus 10 may be configured to preserve the blood-ocular barrier function within the preserved eye. Sensors for this function can be of indirect measurement of viablity of cells using biochemical signaling molecules. The sensors could be electrochemical and optical.

The apparatus 10 may be configured to monitor and regulate the biochemical composition of the vitreous body, including collagen fibrils (types II, V, IX, XI) and glycosaminoglycans (GAGs) such as hyaluronic acid (HA), to maintain its structural integrity. Sensors for this function can be of indirect measurement of viablity of cells using biochemical signaling molecules. The sensors could be electrochemical and optical.

The apparatus 10 may be configured to promote or maintain the viability of limbal epithelial stem cells (LESCs) and corneal stromal stem cells (CSSCs) within the preserved corneal limbus. Sensors for this function can be of indirect measurement of viablity of cells using biochemical signaling molecules. The sensors could be electrochemical and optical.

The apparatus 10 will maintain the viability and functionality of the total eye or the ocular tissues, such as the cornea, retina, and associated structures, following removal from the donor or in preparation for surgical procedures.

The foregoing has described apparatus and methods for ex vivo total eye preservation. While specific embodiments of the present invention have been described, it will be apparent to those skilled in the art that various modifications thereto can be made without departing from the spirit and scope of the invention. Accordingly, the foregoing description of the preferred embodiment of the invention and the best mode for practicing the invention are provided for the purpose of

What is claimed is:

1. An apparatus for perfusing an eye or portions thereof, comprising:
an enclosure configured to provide physical protection to an eye or portions thereof; and
a fluid flow loop extending from an outlet connection of the enclosure to an inlet connection of the enclosure, the fluid flow loop including a pump, an oxygenator, and a waveform generator;
at least one sensor operable to sense a parameter of a perfusate flowing within the fluid flow loop and generate a signal representative thereof; and
a control and monitoring unit configured to receive the signal from the at least one sensor and adjust the parameter in response thereto.

2. The apparatus of claim 1, wherein the enclosure comprises transparent polymer.

3. The apparatus of claim 1, further comprising a lighting system configured to provide gentle illumination within the enclosure.

4. The apparatus of claim 2, wherein the lighting system is limited to specific wavelengths, such as dim red light, to minimize potential damage to the preserved tissues while allowing for observation or imaging purposes.

5. The apparatus of claim 3, wherein the lighting system includes multi-color LEDs.

6. The apparatus of claim 1, wherein the enclosure is provided internally with a flexible hammock configured to support the eye or portions thereof within the enclosure.

7. The apparatus of claim 1, further including a dialysis unit in fluid flow communication with the fluid loop.

8. The apparatus of claim 1, further comprising an intraocular pressure sensor disposed in the enclosure and configured to be placed in contact with or implanted into an eye, so as to enable monitoring of intraocular pressure levels.

9. The apparatus of claim 1, further comprising an electroretinography apparatus configured to assess retinal function.

10. The apparatus of claim 1, further comprising a monitoring system configured to evaluate the responsiveness of ocular tissues to light stimuli.

11. The apparatus of claim 1, further comprising an interferometer with a field of view of an interior of the enclosure and configured to implement Optical Coherence Tomography (OCT) for non-invasive imaging and assessment of ocular structures.

12. The apparatus of claim 1, further comprising an infusion pump operable to introduce at least one additive into the fluid flow loop, the infusion pump operably connected to the control and monitoring unit.

13. A method of perfusing an eye or portions thereof, comprising:
placing the eye or portions thereof in an enclosure configured to provide physical protection to an organ;
coupling the eye or portions thereof to a fluid flow loop including a pump, an oxygenator, and a waveform generator;
using the pump to circulate perfusion fluid through the fluid flow loop;
using the oxygenator to introduce oxygen into the perfusion fluid; and
using the waveform generator to impress a preselected waveform profile upon the fluid flow in the fluid loop.

14. The method of claim 13, further comprising using a lighting system to provide gentle illumination within the enclosure.

15. The method of claim 13, wherein the lighting system is limited to specific wavelengths, such as dim red light.

16. The method of claim 14, wherein the lighting system includes multi-color LEDs.

17. The method of claim 13, further including using a dialysis unit to filter endogenous or exogenous material from the perfusion fluid.

18. The method of claim 13, further comprising using an intraocular pressure sensor to monitor intraocular pressure levels.

19. The method of claim 13, further comprising using an electroretinography apparatus to assess retinal function.

20. The method of claim 13, further comprising using a monitoring system to evaluate the responsiveness of ocular tissues to light stimuli.

21. The method of claim 13, further comprising using an interferometer with a field of view of an interior of the enclosure for non-invasive imaging and assessment of ocular structures.

22. The method of claim 13, further comprising evaluating the responsiveness of ocular tissues to light stimuli which includes dynamic light stimulation protocols to assess retinal ganglion cell activity and quantify tissue functionality.

23. The method of claim 13, further comprising introducing a hydrogel-forming solution into the enclosure, and causing the solution to polymerize in situ around or within the preserved eye or specific ocular tissues to form a hydrophilic vitreous substitute.

24. The method of claim 13, further comprising perforating the vitreous body of the eye with one or more cannulas and perfusing a hydrogel-forming solution to replace and/or regenerate the vitreous body.
